(19) United States
(12) Patent Application Publication
(10) Pub. No.: US 2025/0259001 A1
(43) Pub. Date: Aug. 14, 2025

(54) INDUCED AND DYNAMIC GRAMMAR GENERATION

(71) Applicant: Scaled Cognition, Inc., Amesbury, MA (US)

(72) Inventors: Emmanouil Antonios Platanios, Fremont, CA (US); Adam Pauls, Berkeley, CA (US); Mitchell Stern, Berkeley, CA (US); Mathew Gardner, Irvine, CA (US); Dan Klein, Berkeley, CA (US)

(73) Assignee: Scaled Cognition, Inc., Amesbury, MA (US)

(21) Appl. No.: 18/986,160

(22) Filed: Dec. 18, 2024

Related U.S. Application Data
(60) Provisional application No. 63/551,069, filed on Feb. 8, 2024.

(51) Int. Cl. G06F 40/253; G06F 40/205

(52) U.S. Cl. CPC G06F 40/253; G06F 40/205

(57) ABSTRACT

The present technology, roughly described, generates grammars, such as context free grammars, dynamically and by induction, that can specify constraints for a decoding system. The grammar can be created to support an automated agent involved in an interaction (e.g., a conversation) with a client. In some instances, grammars can be generated dynamically based on copying portions of an interaction history and based on business logic rules. Grammars can also be induced automatically from API specifications and collections of strings. The newly generated context free grammars can be used by a language model to perform constrained decoding.

### CROSS REFERENCE TO RELATED APPLICATIONS

The present application claims the priority benefit of U.S. provisional patent application 63/551,069, filed on Feb. 8, 2024, titled “Intelligent Constrained Decoding,” the disclosure of which is incorporated herein by reference.

### BACKGROUND

Language models generate text for many applications. The text can be generated token by token, where each language model (LM) has tokens that are specific to that particular LM. For LMs to be able to interact with real humans, they must be fast, efficient, and accurate. To achieve these goals, LMs need to be able to call APIs and programs accurately so that the programs and APIs execute correctly. Existing LMs fail at accurately and quickly being able to call APIs and programs. What is needed is an improved LM that operates both accurately and quickly.

### SUMMARY

The present technology, roughly described, generates grammars, such as context free grammars, dynamically, that can specify constraints for a decoding system. In some instances, the present system can automatically construct grammars from API specifications, business logic, and/or datasets of example interactions. These grammars can be “static” as well as “dynamic”. The present system can also automatically construct dynamic grammars based on information that is specific to each request (and thus “dynamic”), like the conversation history thus far in the current conversation.

Dynamic grammars are powerful partially because a system can construct them on the fly for each request, potentially accounting for things that are specific to the present request and not statistically true about all requests. These grammars are much more powerful than static grammars.

The grammar can be created to support an automated agent involved in an interaction (e.g., a conversation) with a client. In some instances, grammars can be generated dynamically based on copying portions of an interaction history and based on business logic rules. Grammars can also be induced automatically from API specifications and collections of strings. The newly generated context free grammars can be used by a language model to perform constrained decoding.

In some instances, the present technology performs a method for automatically inducing a grammar. The method begins with receiving API specification data associated with an API to be accessed by an automated agent. The agent processes a user request received within an interaction between an automated agent and a client. The method then continues by parsing the API specification. The method then automatically constructs a grammar based on the parsed API specification, the automatically constructed grammar to be used in constraining subsequent calls to the API.

In some instances, the present technology performs a method for automatically generating dynamic grammars. The method begins with receiving input data including previous conversation history between a user and an automated agent currently engaged in an interaction. Next, grammar rules are extracted from the input data by an extractor mechanism. The extracted grammar rules are then added to an existing grammar.

In some instances, the present technology includes a non-transitory computer readable storage medium having embodied thereon a program, the program being executable by a processor to automatically induce a grammar. The method begins with receiving API specification data associated with an API to be accessed by an automated agent. The agent processes a user request received within an interaction between an automated agent and a client. The method then continues by parsing the API specification. The method then automatically constructs a grammar based on the parsed API specification, the automatically constructed grammar to be used in representing subsequent calls to the API.

In some instances, the present technology includes a non-transitory computer readable storage medium having embodied thereon a program, the program being executable by a processor to automatically generate a dynamic grammar. The method begins with receiving input data including previous conversation history between a user and an automated agent currently engaged in an interaction. Next, grammar rules are extracted from the input data by an extractor mechanism. The extracted grammar rules are then added to an existing grammar.

In some instances, the present technology includes a system having one or more servers, each including memory and a processor. One or more modules are stored in the memory and executed by one or more of the processors to receive API specification data associated with an API to be accessed by an automated agent that processes a user request received within an interaction between automated agent and a client, parse the API specification, and automatically construct a grammar based on the parsed API specification, the automatically constructed grammar to be used in representing subsequent calls to the API.

In some instances, the present technology includes a system having one or more servers, each including memory and a processor. One or more modules are stored in the memory and executed by one or more of the processors to receive input data including previous conversation history between a user and an automated agent currently engaged in an interaction, extract grammar rules from the input data by an extractor mechanism, and add the extracted grammar rules and an existing grammar a dynamic grammar.

### BRIEF DESCRIPTION OF FIGURES

FIG. 1 is a block diagram of a system for implementing the present technology.

FIG. 2 is a block diagram of an application for constructing a grammar.

FIG. 3 is a block diagram of a grammar module.

FIG. 4 illustrates data flow for a machine learning model.

FIG. 5 is a method of a system for generating grammar.

FIG. 6 is a method for automatically inducing grammar from an API specification.

FIG. 7 is a method for generating grammars dynamically from interaction history.

FIG. 8 is a method for updating a dynamic grammar based on business logic constraints.

FIG. 9 is a block diagram of a computing environment.

### DETAILED DESCRIPTION

The present technology, roughly described, generates a grammar, such as a context free grammar (CFG), that can specify constraints for a decoding system. In some instances, the present system can automatically construct grammars from API specifications, business logic, and/or datasets of example interactions. These grammars can be “static” as well as “dynamic”. The present system can also automatically construct dynamic grammars based on information that is specific to each request (and thus “dynamic”), like the conversation history thus far in the current conversation.

Dynamic grammars are powerful partially because a system can construct them on the fly for each request, potentially accounting for things that are specific to the present request and not statistically true about all requests. These grammars are much more powerful than static grammars.

In some instances, the grammar (e.g., CFG) can be generated dynamically. When generated dynamically, information can be retrieved from the interaction history between the automated agent and the client. For example, an interaction history between the automated agent and the client can be parsed to extract data to be used in a future program, such as a function call, by the automated agent. The interaction history can include the textual content of a conversation between the automated agent and the client, prior predicted programs, and executed program results. The extracted data can include arguments to be used in subsequent API invocations, including but not limited to reservation numbers, identification data, contact data, destination data, and other data that can be passed as a parameter to a subsequent API call.

A grammar is referred to herein as context free grammar (CFG) or sometimes just as grammar. Both terms are intended to relate to a context free grammar.

The CFG can also be dynamically generated to enforce business logic using constrained decoding. For example, if a first API invocation is required before invoking a second API to obtain desired information from the second API, the second API may be disallowed in a dynamic grammar until the first API has been invoked. For example, a client may need to verify their identify using a first API before accessing a record through a second API. In this way, business logic (for example logic that requires a specific sequence of API invocations in order) may be enforced using constrained decoding with a dynamic grammar.

Extractors can parse conversation history (conversation text, predicted programs, executed program results) to identify API arguments and other data. The extraction can be performed before a model invocation as part of a decoding step, and allows for constraining the model's output The grammars can change during the decoding of each string, based on tokens that have been decoded so far, which enables a wider set of grammars that are context sensitive.

In some instances, a CFG can be induced automatically. This automation is a valuable service to administrators of the present system that do not build CFGs themselves. Many language models use APIs consisting of well-defined interfaces with functions that can be invoked, arguments that the functions can take, argument types and return types. APIs also can include documentation for what their functions do, what their arguments correspond to. The present system receives and/or retrieves an API specification and constructs a grammar for representing all valid calls to that API.

The API specification can be in a standardized format, such as for example an OpenAPI specification. The grammar that is automatically induced based on the API specification can include many rules and symbols, all without any input or work on the part of a user of the present system. To automatically induce the grammar, the present system can extract types from the API specification, convert the types to grammar non-terminal symbols, and then construct rules recursively for building function invocations as well as primitive and literal values for certain types. Function declarations from the API can generate grammar rules from the symbols. The newly built function invocations can support both positional and keyword arguments, depending on the desired programming language. The present system can also induce grammars based on collections of example strings that should be included in the language defined by the induced grammar.

The CFG itself includes a set of symbols and a set of production rules, wherein each production rule specifies that a symbol can produce a sequence of other symbols. The symbols can be terminal or non-terminal, such that the terminal do not appear on the left-hand side of production rules. The set of strings allowed by the grammar correspond to sequences of terminal symbols that are the result of one or more applications of production rules in the grammar, starting with a non-terminal symbol called a start symbol.

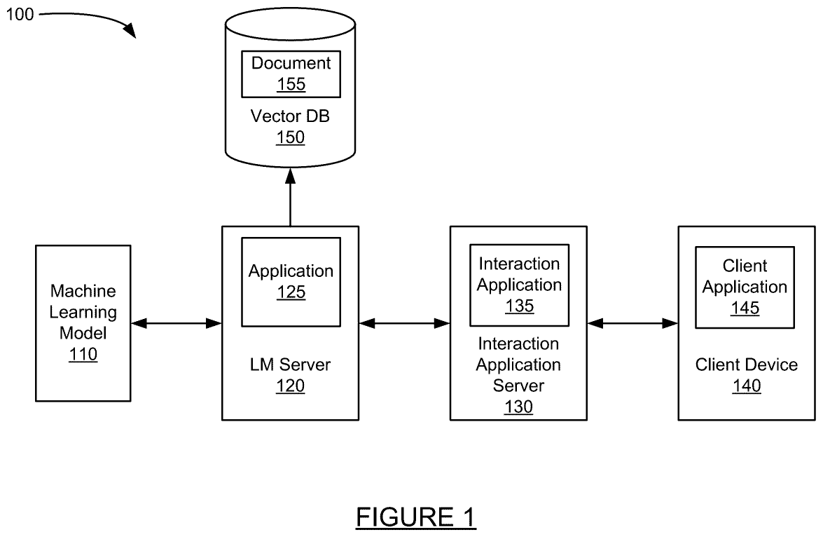

FIG. 1 is a block diagram of a system for implementing the present technology. The system of FIG. 1 includes machine learning model 110, language model server 120, interaction application server 130, client device 140, and vector database 150.

Machine learning model 110 may include one or more models or prediction engines that may receive an input, process the input, and predict an output based on the input. In some instances, machine learning model 110 may be implemented on LM server 120, on the same physical or logical machine as language model application 125. In some instances, machine learning model 110 may be implemented by a large language model, on one or more servers external to LM server 120. Machine learning model 110 may be implemented as one or more models, on one or more machines, and in one or more environments.

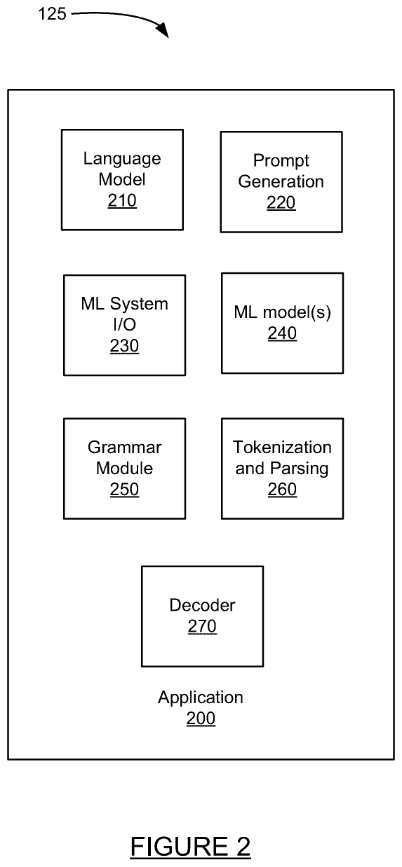

Language model server 120 may be implemented as one or more servers that implement one or more applications 125 that induce a grammar and dynamically generate a grammar as described herein. Application 125 may include a grammar module, tokenization and parsing, a decoder, and other mechanisms in order to produce a grammar used for providing constrained decoding. Application 125 is discussed in more detail with respect to the block diagram of FIG. 2.

In some instances, interaction application server 130 may facilitate an interaction, such as for example a text conversation, between an automated agent provided by server 120 and a client on client device 140. Interaction application 135 on server 130 may communicate with the automated agent and other applications from server 120 and client application 145 to provide an interaction. The interaction may include a text or audio conversation between the automated agent and the client, which may be provided in real time to both the client device and server 120 through one or more interfaces.

Client device 140 may be implemented as a machine remote from server 130. A client at client device 140 can be engaged in an interaction with an automated agent through interaction application server 130. Client device 140 may include a client application 145, implemented as, for example, a mobile app, computer program, and other software.

Vector database 150 may be implemented as a data store that stores vector data. In some instances, vector database 150 may be implemented as more than one data store, internal to system 100 and exterior to system 100. In some instances, a vector database can serve as an LLMs' long-term memory and expand an LLMs' knowledge base. Vector database 150 can store private data or domain-specific information outside the LLM as embeddings. Vector database 150 may include data such as prompt templates, instructions, training data, and other data used by LM application 125 and machine learning model 110.

In some instances, the present system may include one or more additional data stores, in place of or in addition to vector database 150, at which the system stores searchable data such as instructions, private data, domain-specific data, and other data.

Each of model 110, servers 120-130, client device 140, and vector database 150 may communicate over one or more networks. The networks may include one or more the Internet, an intranet, a local area network, a wide area network, a wireless network, Wi-Fi network, cellular network, or any other network over which data may be communicated.

In some instances, one or more of machines associated with 110, 120, 130 and 140 may be implemented in one or more cloud-based service providers, such as for example AWS by Amazon Inc, AZURE by Microsoft, GCP by Google, Inc., Kubernetes, or some other cloud based service provider.

The system of FIG. 1 illustrates a language model application within an automated agent system formed with ML model 110, LM server 120, and client device 140. Illustration of the language model in an automated agent system is for purposes of discussion only, and the language model of the present technology is not intended to be limited to automated agent systems alone.

FIG. 2 is a block diagram of an application for constructing a grammar as part of a constrained decoding system. Application 200 provides more detail for application 125 of FIG. 1. Application 200 includes language model 210, prompt generation 220, machine learning system I/O 230, machine learning model 240, grammar module 250, tokenization and parsing 260, and decoder 270.

Language model 210 may be used with one or more grammars, vocabularies, and other content. The language model may be implemented as one or more applications or modules that construct sentences from content created by the present system.

Prompt generation 220 may generate a prompt to be provided to a large language model or other machine learning model. Prompt generation 220 may access content such as conversation history, invoked programs, and other content from an interaction between an automated agent and a customer in order to generate a prompt. A generated prompt may include one or more requests, all or part of a CFG, one or more previous tokens, a user inquiry, conversation data, instructions retrieved based on the user inquiry, audit data, and optionally other data. The request may indicate what the large language model is requested to do, for example determine a probability that each of several tokens is the best token, determine a next state from the current state, determine a response for a user inquiry, select a function or program to be executed, perform an audit of a predicted response or other step, or some other goal.

Machine learning system I/O 230 may communicate with a local or remote machine learning model, for example to provide a prompt and receive machine learning model output. Machine learning system I/O may retrieve input from, for example, prompt generation unit 220 and retrieve output from machine learning model 110.

Machine learning (ML) model(s) 240 may include one or more machine learning models that generate predictions, receive prompts, instructions, and requests to provide a response to particular inquiry, as well as perform other tasks. The machine learning models 240 can include one or more LLMs, as well as a combination of LLMs and ML models.

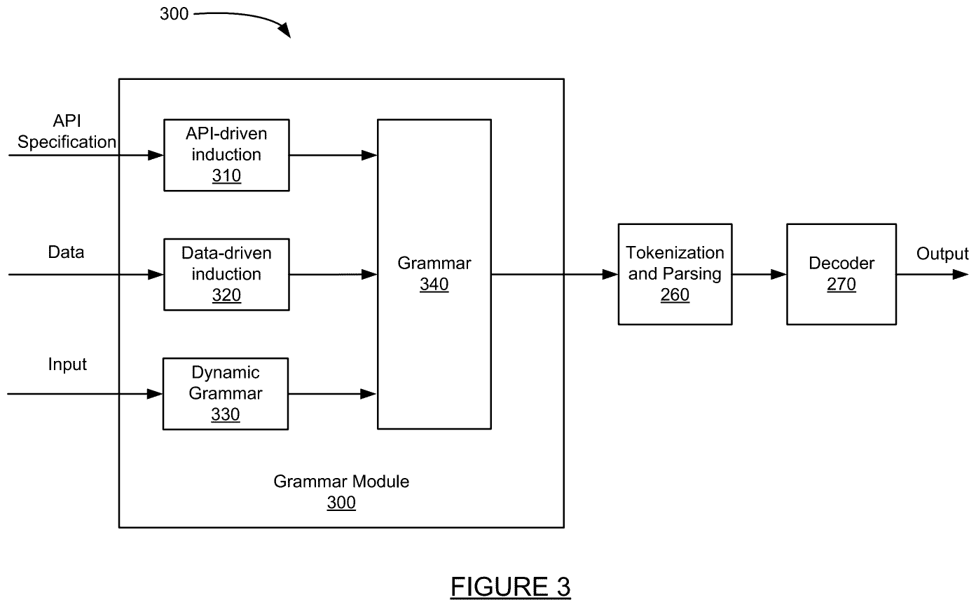

Grammar module 250 may induce grammars and dynamically generate grammars for use in generating text for a conversation with a client. Grammar module 250 is discussed in more detail with respect to FIG. 3.

Tokenization and parsing module 260 may use a grammar to generate content to be decoded and output by the present system. Decoder 270 may receive the tokenized and parsed language content and generate text content to be used in the interaction with a client.

FIG. 3 is a block diagram of a grammar module. The grammar module 300 of FIG. 3 provides more detail of grammar module 250 of FIG. 2. Grammar module 300 induces grammars and dynamic generates grammars. Grammars may be induced based on an API specification data that is received by API-driven induction 310. API-driven induction 310 receives the API specification, retrieves API information such as function, argument and other call data, and dynamically constructs grammars representing all valid calls to the API. The dynamically generated grammars generated from the API specification are then added to grammar 360.

Data driven induction module 320 receives data, such as string data, and induces grammars based on the collections of the example strings received. The data induced grammars are then added to grammar 360.

Dynamic grammar 330 receives input and dynamically creates grammars to be added to grammar 360. The received input can include interaction history data (conversation text, prior predicted programs, executed programs, and executed program results). Extractor mechanisms within dynamic grammar 330 can extract dynamic grammar rules from the conversation history before the system makes a model (machine learning, large language model, or other model) invocation to perform constrained decoding. The grammar rules may relate to API arguments or other data contained in past conversation text, programs, or results that may be used in a currently invoked or subsequently invoked API.

Dynamic grammar 330 can also generate dynamic grammars that enforce business logic when performing constrained decoding. For example, if a particular result from a first API is required before invoking a second API, the second API may be disallowed in a dynamic grammar until the first API has been invoked. Once the first API is invoked and the particular result is received, the second API may be dynamically added to the grammar upon receiving the particular result. In this way, business logic (for example business logic that requires sequential or nested API calls) may be enforced using constrained decoding with a dynamic grammar.

The grammars automatically constructed from API specifications, business logic, and/or datasets can be “static” as well as “dynamic”. The present system can automatically construct dynamic grammars based on information that is specific to each request (and thus “dynamic”), like the conversation history thus far in a conversation. The Dynamic grammars are powerful at least because the present system can construct them on the fly for each request, potentially accounting for things that are specific to the present request and not statistically true about all requests. Grammar 360 is provided to tokenization parsing unit 260. After tokenization and parsing of the grammar, the tokenized and parsed output is provided to decoder 270. Decoder 270 then generates an output to be sent to interaction application 135 on interaction application server 130.

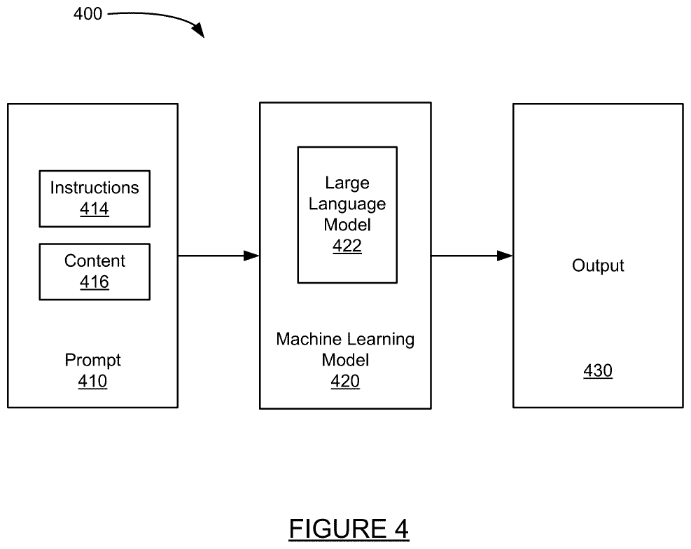

FIG. 4 illustrates data flow for a machine learning model. The block diagram of FIG. 4 includes prompt 410, machine learning model 420, and output 430. Prompt 410 of FIG. 4 can be provided as input to a machine learning model 420. A prompt can include information or data such instructions 414 and content 416.

Instructions 414 can indicate what the machine learning model (e.g., a large language model) is supposed to do with the content provided in the prompt. For example, the machine learning model instructions may request, via instructions 414, an LLM to predict a probability that a particular token is the next token in a sequence of tokens, determine if a predicted response was generated with each instruction followed correctly, determine what function to execute, determine whether or not to transition to a new state within a state machine, and so forth. The instructions can be retrieved or accessed from document 155 of vector database 150, locally at a server that communicates or hosts the machine learning model, or from some other location.

Content 416 may include data and/or information that can help a ML model or LLM generate an output. For an ML model, the content can include a stream of data that is put in a processable format (for example, normalized) for the ML model to read. For an LLM, the content can include sequences of tokens, a conversation between an agent and a user, a grammar, a user inquiry, retrieved instructions, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 420 of FIG. 4 provides more detail for machine learning model 110 of FIG. 1. The ML model 420 may receive one or more inputs and provide an output. ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential

data. LLMs receive text as an input through a prompt and provide a response to one or more instructions. For example, an LLM can receive a prompt as an instruction to analyze data.

In some instances, the present technology may use an LLM such as a BERT LLM, Falcon 30B on GitHub, Galactica by Meta, GPT-3 by OpenAI, or other LLM. In some instances, machine learning model 115 may be implemented by one or more other models or neural networks.

Output 430 is provided by machine learning model 420 in response to processing prompt 410 (e.g., an input). For example, when the prompt includes a request that the machine learning model provide a probability that a particular token is the next token in a sequence, the output will include a probability. The output can be provided to other parts of the present system.

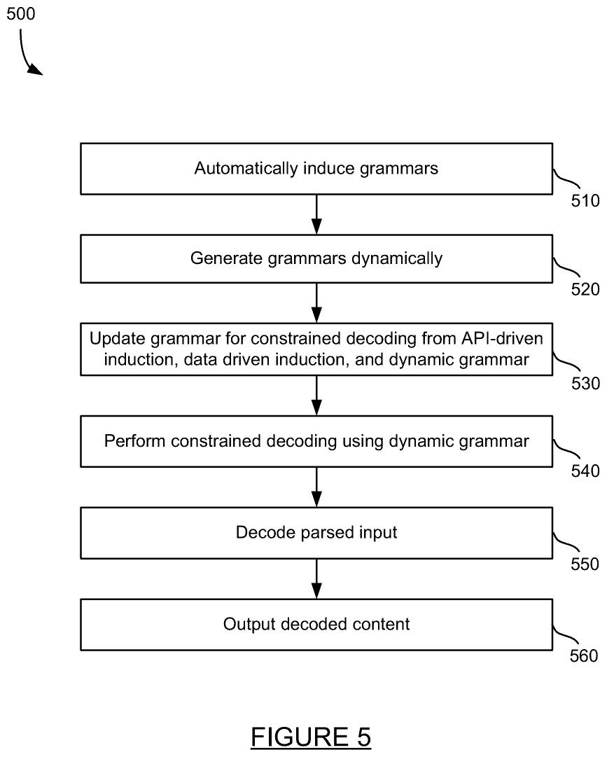

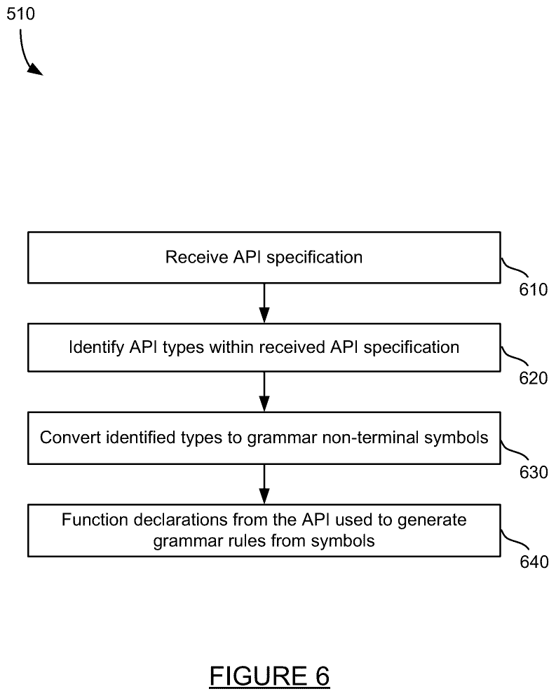

FIG. 5 is a method for generating a CFG for constrained decoding. Grammar is automatically induced at step 510. Grammars may be induced from an API specification or data, such as example strings. Extractors can process the API specification and/or example strings and generate grammar rules. Automatically inducing grammars from an API specification is discussed in more detail with respect to the method of FIG. 6.

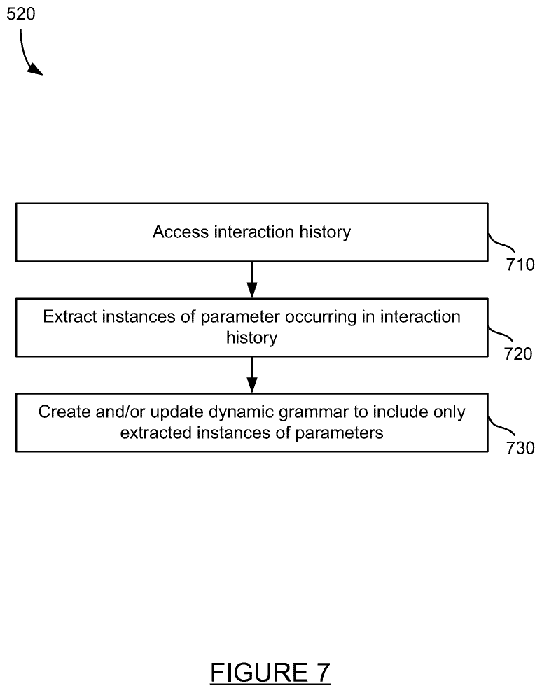

Grammars are generated dynamically at step 520. Dynamically generating grammars may include accessing interaction history from an interaction between an automated agent and a client, extracting elements from the conversation history, and constructing grammar rules from the extracted elements. Generating a grammar based on constraints copied from or extracted from conversation history is discussed further with respect to the method of FIG. 7.

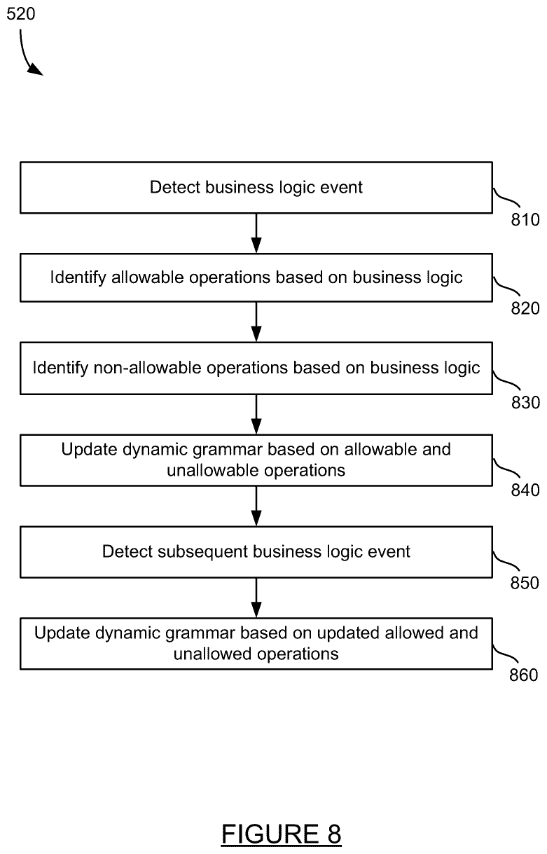

Grammars can be also dynamically generated based on business logic events. To dynamically generate grammars based on business logic events, business logic is determined based on allowed and un-allowed operations, for example as operations detected within a conversation. Dynamically generating grammars based on business logic events is discussed in more detail with respect to FIG. 8.

A CFG for constrained decoding is updated from one or more of API induced grammars, data inducted grammars, and dynamically generated grammar at step 530. Constrained decoding is then performed using the dynamic grammar at step 540. Constrained decoding may be performed by logic and code stored locally or by code on one or more remote machines.

In some instances, performing constrained decoding can include utilizing a large language model (LLM). This process may begin with preparing a prompt for the LLM. The prompt can be generated using a constrained grammar with extracted instance rules. The generated prompt can then be submitted to the LLM. The LLM receives the prompt, processes the prompt, and provides an output. The LLM output includes results of the constrained decoding and is generated based on the prompt and constrained grammar.

Once grammar is generated, grammar is parsed and decoded at step 550. The decoded content is then output, for example to an interaction with a customer, at step 560.

FIG. 6 is a method for automatically inducing grammar from an API specification. The method of FIG. 6 provides more detail for step 510 of the method of FIG. 5. An API specification is received at step 610. API types are identified within the received API specification at step 620. The types can include function return types and their argument types. The identified types are converted into grammar non-terminal symbols at step 630. Function declarations from the API are then used to generate the grammar rules from symbols at step 640. The rules can be constructed for building function invocations, supporting both positional and keyword arguments, as well as for building primitive and literal values for certain types.

In some instances, grammar induction can be performed from data showing example interactions. For example, an example interaction with an input-output pair can be used to perform grammar induction. The present system can compute statistics from the example interactions to determine what should not be allowed. A grammar can then be constructed from the statistics, for example a grammar constraint on portions that statistically should be allowed. The statistics can show what programs are good (i.e., should be allowed) and what programs are bad (i.e., should not be allowed), and the grammar can be induced by known good programs.

FIG. 7 is a method for generating grammars dynamically from interaction history. The method of FIG. 7 provides more detail for step 520 of the method of FIG. 5. An interaction (for example, a conversation between the present system and a customer or client) history associated with an interaction between an agent and a client is accessed at step 710. The interaction history can include, but is not limited to, the text conversation between the agent and client, programs predicted and invoked, and results of invoked programs. Instances of API parameters occurring in the conversation history are then extracted at step 720. The API parameters can include arguments, field values, and other values. In some instances, an API previously predicted or invoked is processed to extract parameters and field types and formats, and the textual conversation history is parsed based on the extracted parameter data. The system then creates and/or updates a dynamic grammar to include rules based on the extracted instances of API parameters at step 730.

FIG. 8 is a method for updating a dynamic grammar based on business logic constraints. The method of FIG. 8 provides more detail for step 520 of the method of FIG. 5. A business logic event is detected at step 810. A business logic event may include a call to a particular API, a client request, or some other business logic event.

Allowable operations are then identified based on business logic at step 820. The business logic may include a set of rules which must be followed by an automated agent in an interaction between an automated agent and a client. For example, a business logic rule may require a client to provide a destination before the automated agent retrieves flight information, or for an automated agent to confirm a client's identity before providing airline reservation information. Non-allowable operations are identified based on business logic at step 830.

A dynamic grammar is then updated based on allowable and unallowable operations at step 840. For example, if a first API invocation is required before invoking a second API to obtain desired information from the second API, the second API may be disallowed in a dynamically generated grammar until the first API has been invoked.

Subsequent business logic events are detected at step 850. A dynamic grammar is then updated based on the updated allowed and on allowed operations at step 860. Continuing the example, once the first API has been invoked, the system may dynamically generate a grammar that allows invocation of the second API.

In some instances, a dynamic grammar can be updated based on a combination of constraints, such as both copy constraints and business logic constraints. For example, an event may occur in the interaction history between an automated agent and a customer that changes what would be allowed according to business logic constraints. In this example, the copy constraint is used to dynamically update the grammar based on an interaction event, and the business logic constraint is used to dynamically update the grammar based on changes to what is allowed based on the business logic constraint.

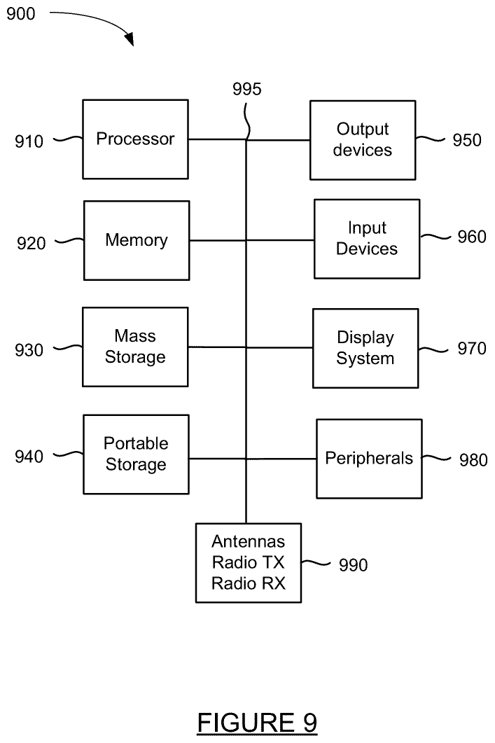

FIG. 9 is a block diagram of a computing environment for implementing the present technology. System 900 of FIG. 9 may be implemented in the contexts of the likes of machines that implement machine learning model 110, application server servers 120 and 130, client device 140, and vector datbase 150. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 995. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive, an optical disk drive, a flash drive, or other device, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a floppy disk, compact disk or Digital video disc, USB drive, memory card or stick, or other portable or removable memory, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information and processes the information for output to the display device. Display system 970 may also receive input as a touch-screen.

Peripherals 980 may include any type of computer support device to add additional functionality to the computer system. For example, peripheral device(s) 980 may include a modem or a router, printer, and other device.

The system of 900 may also include, in some implementations, antennas, radio transmitters and radio receivers 990. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for automatically inducing a grammar, comprising:
receiving API specification data associated with an API to be accessed by an automated agent that processes a user request received within an interaction between automated agent and a client;
parsing the API specification; and
automatically constructing a grammar based on the parsed API specification, the automatically constructed grammar to be used in representing subsequent calls to the API.

2. The method of claim 1, wherein the grammar is generated automatically without user input.

3. The method of claim 1, wherein the API specification is in an industry-standard format.

4. The method of claim 3, wherein inducing a grammar includes:
detecting one or more types within the API specification;
converting the types to grammar non-terminal symbols; and
constructing grammar rules using function declarations from the API, wherein the types include function return types and argument types.

5. The method of claim 1, wherein the grammar is induced by a collection of known good programs.

6. A method for automatically generating a dynamic grammar based on business logic, comprising:
identifying two or more APIs that require invocation in a specific order based on business logic;
dynamically creating a grammar rule to enforce the order of the invocation of the two or more APIs based on business logic; and
adding the dynamically created grammar rule to an existing context free grammar.

7. A method for automatically generating a dynamic grammar, comprising:
identifying a first API that is required to be invoked before invoking a second API;
extracting grammar rules from the input data by an extractor mechanism; and
adding the extracted grammar rules and an existing grammar to a dynamic grammar.

8. The method of claim 7, wherein extracting includes:
identifying API arguments within the previous conversation history by the extractor mechanism; and
dynamically creating grammar rules to allow constrained decoding based on the dynamically created grammar rule.

9. The method of claim 7, wherein the input data includes prior predicted programs and executed programs and their results within the current conversation.

10. The method of claim 7, further comprising:
identifying a first API that is required to be invoked before invoking a second API; and
dynamically creating a grammar rule to enforce the invocation of the second API only after the first API has been invoked.

11. A non-transitory computer readable storage medium having embodied thereon a program, the program being executable by a processor to automatically inducing a grammar, the method comprising:
receiving API specification data associated with an API to be accessed by an automated agent that processes a user request received within an interaction between automated agent and a client;
parsing the API specification; and
automatically constructing a grammar based on the parsed API specification, the automatically constructed grammar to be used in representing subsequent calls to the API.

12. The non-transitory computer readable storage medium of claim 11, wherein the grammar is generated automatically without user input.

13. The non-transitory computer readable storage medium of claim 11, wherein the API specification is in a standardized format.

14. The non-transitory computer readable storage medium of claim 11, wherein inducing a grammar includes:
detecting one or more types within the API specification;
converting the types to grammar non-terminal symbols; and
constructing grammar rules using function declarations from the API based on the non-terminal symbols, wherein the types include function return types and argument types.

15. The non-transitory computer readable storage medium of claim 11, wherein the grammar is induced by a collection of known good programs.

16. A non-transitory computer readable storage medium having embodied thereon a program, the program being executable by a processor to automatically generating a dynamic grammar, the method comprising:
receiving input data including previous conversation history between a user and an automated agent currently engaged in an interaction;
extracting grammar rules from the input data by an extractor mechanism; and
adding the extracted grammar rules and an existing grammar a dynamic grammar.

17. The non-transitory computer readable storage medium of claim 16, wherein extracting includes:
identifying API arguments within the previous conversation history by the extractor mechanism; and
dynamically creating grammar rules to allow constrained decoding based on the dynamically created grammar rule.

18. The non-transitory computer readable storage medium of claim 16, wherein the input data includes prior predicted programs and executed programs and their results within the current conversation.

19. The non-transitory computer readable storage medium of claim 16, further comprising:
identifying a first API that is required to be invoked before invoking a second API; and
dynamically creating a grammar rule to enforce the invocation of the second API only after the first API has been invoked.

20. A system for automatically inducing a grammar, comprising:
one or more servers, wherein each server includes a memory and a processor; and
one or more modules stored in the memory and executed by at least one of the one or more processors to receive API specification data associated with an API to be accessed by an automated agent that processes a user request received within an interaction between automated agent and a client, parse the API specification, and automatically construct a grammar based on the parsed API specification, the automatically constructed grammar to be used in representing subsequent calls to the API.

21. A system for automatically generating a dynamic grammar, comprising:
one or more servers, wherein each server includes a memory and a processor; and
one or more modules stored in the memory and executed by at least one of the one or more processors to receive input data including previous conversation history between a user and an automated agent currently engaged in an interaction, extract grammar rules from the input data by an extractor mechanism, and add the extracted grammar rules and an existing grammar a dynamic grammar.
